(19) United States
(12) Patent Application Publication
(10) Pub. No.: US 2016/0373735 A1
(43) Pub. Date: Dec. 22, 2016

(54) Method For Encoding Four Bits Color Construct Code

(71) Applicant: Telekom Malaysia Berhad, Kuala Lumpur (MY)

(72) Inventors: NOR FAZLINA IRYANI BINTI ABDUL HAMID, Puchong (MY); SITI SALWA BINTI SAID, Puchong (MY); HUSNIZA BINTI RAZALLI, Serdang (MY); ROZANUDIN BIN SAMSUDIN, Sungai Petani (MY); ABDUL MANAF BIN MAMAT, Kajang (MY); SHUHAILI BINTI SAFEE, Kuala Terengganu (MY); AHMAD ZAIDEE BIN ABU, Seri Kembangan (MY); ZUBAIRY BIN ISMAAIL, Kuala Lumpur (MY); MOHAMAD BIN DRAMAN, Putrajaya (MY)

(21) Appl. No.: 15/183,970

(22) Filed: Jun. 16, 2016

(30) Foreign Application Priority Data
Jun. 18, 2015 (MY) PI 2015001560

(51) Int. Cl. H04N 19/10; H04N 19/186; H04N 19/184

(52) U.S. Cl. CPC H04N 19/10; H04N 19/184; H04N 19/186

(57) ABSTRACT

A method for encoding and decoding multi-colored color code for storage of digital data into two-dimensional color codes, where the input data can be either a text file, audio or video files, the color codes comprising 4-bit color cells, allowing for improved and with higher density of data storage and easier decoding to retrieve the original content. After optional steps of applying compression and encryption, the resulting bit-stream is broken into 4-bit units, which is used to translate into 16-color cells. The resulting color cells are distributed around the output color code, to increase the ability of correcting errors that crop up during code transfer.

### FIELD OF THE INVENTION

The present invention relates to two-dimensional color code (3 bits

CCC). More particularly, the present invention relates to a method to obtain a multicolor and reduced cell which converts digital data into two-dimensional color code (3 bits CCC).

### BACKGROUND OF THE INVENTION

The innovation of various barcode designs functions are to record and store data information via Secured Printable Digital Data platform. The conventional 1-dimensional black-and-white code that are still being used widely can only store short numerical data. The 2-dimensional black and white code can improve data capacity but is limited to certain character-sets and cannot store larger electronic data such as image and video. Black and white code represents the binary bit for each grid.

To increase the density of data, the invention proposes to add colors with bit values for each cell. The present color code represents eight colors makes per cell which can store 3 bits data. There are existing patented technologies/prior arts relating to the Color Code, such as Information Code viewer under U.S. Patent No. US 2011/0110586 A1 and Method For Creating and Method for Decoding Two- Dimensional Color Code viewer under EP 2 544 128 A1.

The claim of this invention is that, the more colors are used, the higher the density. When sixteen colors are used, each cell carries 4 bits of information instead of 3 bits. The improvement of data density by this invention allows for more data not possible under the traditional black-and-white code.

The basic colors used are modeled using RGB color space. For sixteen colors, the color-separation is more complicated, the method of which has to be identified. An optimization method is therefore used to cluster each colors around RGB color space. Thus, the method can avoid the color mixing with others colors.

### DISCLOSURE OF INVENTION

The present invention aims to obtain a multicolor and reduced cell which converts digital data into two-dimensional color code. The data conversion to digital data such as text, image, audio and video into 4 bits Color Code results in improved and enhanced data storage, presenting an advantage over the existing prior art. This therefore eliminates and overcomes the existing problems prevalent in the prior art that uses only a 2-dimensional 3-bit color code with limited size/storage capacity.

The size for each cell is fixed into 10×10 dot. But, it's better if the size for each cell is smaller than 10×10 pixel to store more data capacity as in the subject invention. The size of cells is determined based on digital-camera or smartphone-camera resolution for easier processing to decode the image of Color Code.

For generation of data Color Code, the input (compressed/encrypted/reed Solomon) bitstream are taken as 4 bits and translated to color. The colors for 4 bits Color Code are 16 colors which include red, blue, green lime, cyan, magenta, yellow, black, white, maroon, teal, green, navy blue, purple, silver, gray, and olive. Each color of cell carries data information containing error correction codes. The information is written in distributed fashion method inside the color grid to ensure that interruption in certain part cell does not affect the decode process. This generates precise and easy to read data records.

### BRIEF DESCRIPTION OF THE DRAWINGS

FIG. 1 shows a Process Flow for Encoding illustrating an overview of the proposed methodology according to the preferred embodiment of the invention;

FIG. 2 shows a process of Distributed Fashion to ensure the interruption in certain part cell does not affect the decode process;

FIG. 3 shows an example of CCC Encoded Data Image representation.

### DESCRIPTION OF THE PREFERRED EMBODIMENT

The invention will now be described in greater detail, by way of example, with reference to the drawings.

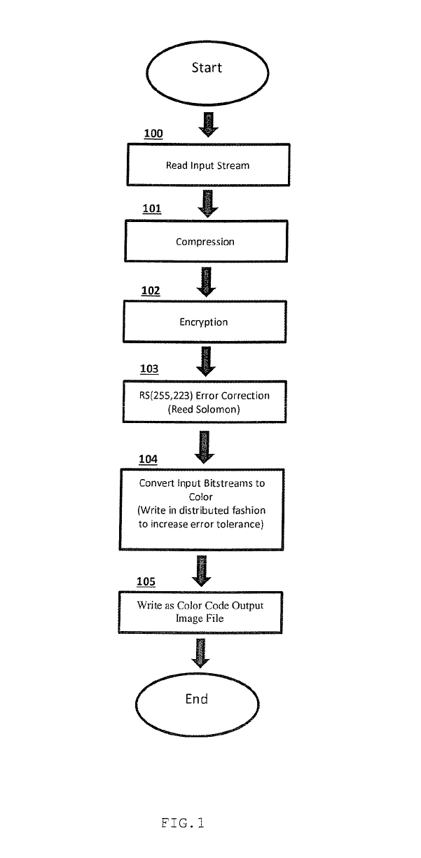

Referring to FIG. 1. source file is read and processed directly regardless of the format (100). During processing of the source file, the file attributes are captured and stored as part of the

Guide Code. Some of the attributes captured are the (compressed) source file length, its type, its file format, the code's cell size, the code's cell column count, encrypted and compressed markers, and number of bits per cell. A minimum of 26 colors including left most Black and right most Blue Positional Guide which is used for determining the rotation and flipping of the code during decoding. Thus, the rest of 24 colors represent the file attributes which consist of 16 bits (8 colors) for (compressed) source file Length, 4 bits (2 colors) for it's file type, 4 bits (2 colors) for its file format, 4 bits (2 colors) for cell size, 16 bits (8 colors) for cell column count, 2 bits (1 color) for encrypted & compressed markers, and 2 bits (1 color) for number of bits per color. Other colors beyond the 26 colors are simply paddings to ensure the total columns are as the same size as Data Color Code. Data color code consists of 4 bits actual bit-streams data (with compression and/or encryption and or Reed-Solomon error detection and recovert code applied as nessesary) represented as 16 different colors.

Since a raw source data may be producing bigger CCC image when encoded, it is best to compress the source data first to reduce the size of the bit-stream before conversion into Color Code (101). When desired, the input file can be compressed according to the best available method. In the same way, the input file can be encrypted with RC4, given a password. Source data file of type text and audio (MIDI) are compressed with Huffman Coding encryption method, while graphical images and short videos are down-sampled as JPEG and MP4 formats.

To allow users or service providers to restrict access to the decoded data, RC4 encryption is used (102). For the purposes of simplicity and fast-processing, simple symetrical encryption is used. RC4 with reasonably strong password is deemed enough to provide data hiding from unintended parties.

When CCC image is captured with a camera, resulting captured images are expected to have errors in the image reproduction, either due to technical limitations of the camera, or deliberate image distortions like spilled ketchup. With Error detection and correction mechanism (103), errors creeping from above scenario can be reduced. For this invention, Reed-Solomon (RS), with parameters RS(255, 223) is used.

For every 223 bytes of source (compressed or/and encrypted) data, 32 bytes of RS Error Detection and Correction codes is appended to the data to make a 255-byte RS system chunks.

Depending on the number of bits per color setting used during encoding, bits are taken from right to left of every byte and encoded into an RGB color (104). Since the the claim of this invention specifies 4-bits per cell, the code can be presented with 16 different colors. 4 bits sequence converts into 16 different color such as “0000=1=red”, “0001=2=green lime”, “0010=3 =blue”, “0011=4 =cyan”, “0100=5=magenta”, “0101=6=yellow”, “0110 =7 =black”, “0111=8 =white”, “1000=9=maroon”, “1001=10=teal”, “1010=11=green”, “1011=12=navy blue”, “1100=13=purple”, “1101=14=silver”, “1110=15=gray”, and “1111=16=olive”. The RGB color model values representing the color are:
RGB(255, 0, 0) for Red,
RGB(0, 255, 0) for Green Lime,
RGB(0, 0, 255) for Blue,
RGB(0, 255, 255) for Cyan,
RGB(255, 0, 255) for Magenta,
RGB(255, 255, 0) for Yellow,
RGB(0, 0, 0) for Black,
RGB(255, 255, 255) for White
RGB(128, 0, 0) for Maroon,
RGB(0, 128, 128) for Teal,
RGB(0, 128, 0) for Green,
RGB(0, 0, 128) for Navy Blue,
RGB(128, 0, 128) for Purple,
RGB(192, 192, 192) for Silver,
RGB(128, 128, 128) for Gray,
RGB(128, 128, 0) for Olive

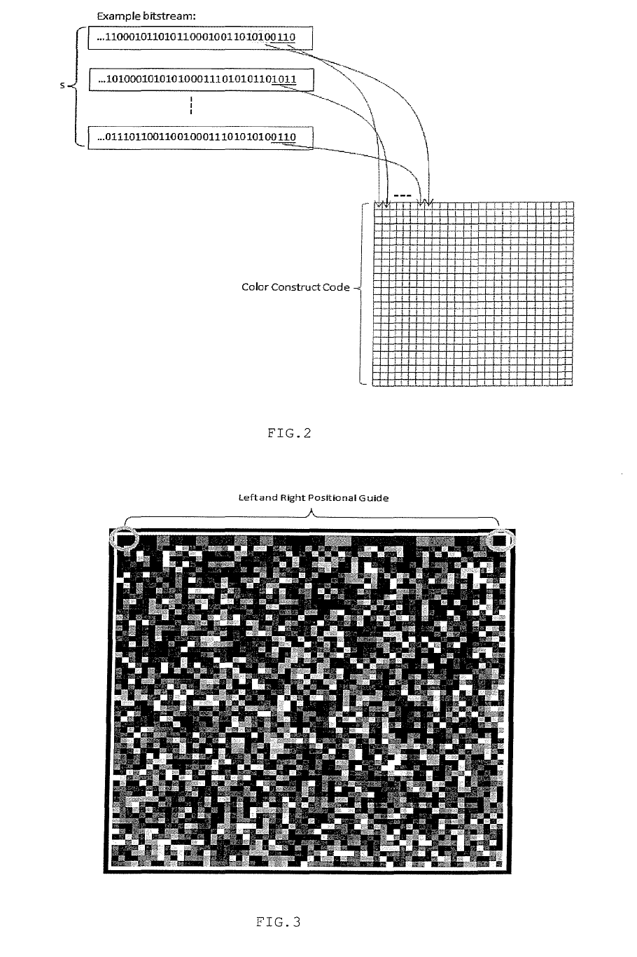

After the conversion, the colored cell is written in a distributed fashion (FIG. 2) based on the total of RS Systems available, to increase the error tolerance during decoding. Every system will contain 255 bytes of data which is equivalent to 2040 (255*8) bits. This is equivalent to 510 (2040/4) colors for 4 bits per color system. The total number of a RS System for RS(253,223) will be based on size of (compressed/ encrypted) source file divided by 223. For every system 32 bytes are then used for parity error correction code. The information in each system is carried up to each cell as So, xₙ=1+s(n), where n=0, 1, 2, 3, . . . and s=number of system. Then, the result is coded as Color Code output in image file (105). The outer black box represents a fixed area used for the purpose of feature detection and image cropping during image processing. Immediately within the black box, there are 2 different areas of code, one is where the cells are twice as large than the other area but runs only a single row, while the other, the cells are smaller and covers the rest of the space. The former is refered to as the Guide Code. (FIG. 3).

What is claimed is:

1. A method of generating multi-colored cells in a color code characterized in that increases color code image density by converting digital data into two-dimensional color code.

2. A method as in claim 1, characterized in that there is conversion to digital data comprising text, image, audio or video files into 4-bits color code.

3. A method as in claim 1 characterized in that the conversion to digital data results in improved code density.

4. A method as in claim 1, characterized in that the size of cells is determined based on digital camera or smartphone camera resolutions determining the ability to process the image of color code.

5. A method as in claim 1, characterized in that, compressed and/or encrypted color code data input bit-stream are broken into 4-bit chunks and translated into colors.

6. A method as in claim 1, characterized in that, the colors for 4-bits color code comprises 16 colors; red, blue, green, lime, cyan, magenta, yellow, black, white, maroon, teal, green, navy blue, purple silver, grey and olive.

7. A method as in claim 1, characterized in that, each color cell carries data information containing error detection and correction codes where information is written in distributed fashion method inside the color cell ensuring minimal interruption in cell parts so as not to affect the decoding process, generating in consequence a precise and easy to read data records.
